(19) United States
(12) Patent Application Publication
(10) Pub. No.: US 2009/0297041 A1
(43) Pub. Date: Dec. 3, 2009

(54) SURROUNDING RECOGNITION SUPPORT SYSTEM

(75) Inventors: Noboru NAGAMINE, Anjo-shi (JP); Kazuya WATANABE, Anjo-shi (JP)

Correspondence Address: SUGHRUE MION, PLLC, 2100 PENNSYLVANIA AVENUE, N.W., SUITE 800, WASHINGTON, DC, 20037, US

(73) Assignee: AISIN SEIKI KABUSHIKI KAISHA, Kariya-shi (JP)

(21) Appl. No.: 12/475,834

(22) Filed: Jun. 1, 2009

(30) Foreign Application Priority Data
Jun. 2, 2008 (JP) 2008-144698

(51) Int. Cl. G06K 9/62

(52) U.S. Cl. 382/209

(57) ABSTRACT

A surrounding recognition support system includes an image processing portion receiving a captured image of a surrounding of a vehicle and performing an image processing on the captured image received, an object position detecting portion detecting a position of an object present in a vicinity of the vehicle, an object identification portion identifying information related to the object, a formative image generation portion generating a formative image that suggests a presence of the object existing within a specific area and existing out of an image captured area of the image capturing device, the object being identified by the object identification portion, and a display image control portion performing an image compositing process on the formative image and the captured image on which the image processing has been performed, and outputting a composite image obtained resulting from the image compositing process to a display device installed within the vehicle.

### CROSS REFERENCE TO RELATED APPLICATIONS

This application is based on and claims priority under 35 U.S.C. § 119 to Japanese Patent Application 2008-144698, filed on Jun. 2, 2008, the entire content of which is incorporated herein by reference.

### FIELD OF THE INVENTION

The present invention relates to a surrounding recognition support system.

### BACKGROUND

A technology for supporting or assisting a driver to operate a vehicle and to observe surroundings of the vehicle when the driver parks the vehicle is known. For example, JP2007-114057A discloses an obstacle detection apparatus for highly accurately and reliably obtaining a shape of an obstacle in three dimensions based on an image of surroundings of a vehicle and a distance between the vehicle and the obstacle present in the vicinity of the vehicle. The shape in three dimensions of the obstacle acquired in the aforementioned manner is superimposed on the image of the surroundings of the vehicle to thereby inform the driver of the obstacle. As a result, the driver surely recognizes the obstacle so that a collision therewith can be prevented.

In addition, JP2007-004697A discloses an object recognition apparatus including a shape recognizing means for recognizing a shape of an outline of an object based on surface shape information of the object present in the vicinity of a vehicle, which is acquired by a distance sensor. Based upon a recognition result of the outline shape of the object by the shape recognizing means and distance information between the vehicle and the object acquired by the distance sensor, a relative position between the vehicle and the object is calculated and displayed on an informing means such as a display screen, being superimposed on the captured image of the surroundings of the vehicle. Alternatively, the relative position may be informed to the driver via voice or sound. Accordingly, a collision with an obstacle is prevented and the driver can safely park the vehicle.

Each of the aforementioned obstacle detection apparatus and the object recognition apparatus is a so-called parking assist apparatus for assisting a driving operation of the driver by informing the driver of information such as a parked vehicle adjacent to a parking space targeted by a present vehicle and an obstacle present on or around a driving path of the present vehicle. Thus, an object present within an area that cannot be confirmed or checked on the display, i.e., an object present out of an image captured area by an image capturing device is not detectable. In addition, the driver's attention is focused on the display screen while the driver is parking the vehicle. Thus, the driver may not recognize or notice an object, for example, a pedestrian approaching the vehicle from an outside of the image captured area.

According to a currently commercially available parking assist apparatus, the driver is encouraged to visually check an area out of the image captured area via a voice or a message displayed on the display screen. However, because an obstacle itself is not displayed on the display screen, the driver may not visually check the surroundings of the vehicle.

A need thus exists for a surrounding recognition support system which is not susceptible to the drawback mentioned above.

### SUMMARY OF THE INVENTION

According to an aspect of the present invention, a surrounding recognition support system includes an image processing portion receiving a captured image of a surrounding of a vehicle from an image capturing device and performing an image processing on the captured image received, an object position detecting portion detecting a position of an object present in a vicinity of the vehicle, an object identification portion identifying information related to the object based on a detection result of the object position detecting portion, a formative image generation portion generating a formative image that suggests a presence of the object existing within a specific area and existing out of an image captured area of the image capturing device, the object being identified by the object identification portion, and a display image control portion performing an image compositing process on the formative image and the captured image on which the image processing has been performed, and outputting a composite image obtained resulting from the image compositing process to a display device installed within the vehicle.

### BRIEF DESCRIPTION OF THE DRAWINGS

The foregoing and additional features and characteristics of the present invention will become more apparent from the following detailed description considered with the reference to the accompanying drawings, wherein:

FIG. 1 is a block diagram schematically illustrating a structure of a surrounding recognition support system according to a first embodiment of the present invention;

FIG. 2 is a diagram illustrating an example of an identification of an object present within a specific area out of an image captured area;

FIG. 3 is a diagram illustrating an example of an imaginary shadow of an object displayed on a display;

FIG. 4 is a diagram illustrating another example of the object displayed on the display;

FIG. 5 is a block diagram schematically illustrating a structure of a surrounding recognition support system according to a second embodiment of the present invention; and

FIG. 6 is a diagram illustrating an example of an identification of an object according to the second embodiment of the present invention.

### DETAILED DESCRIPTION

A first embodiment of the present invention will be explained with reference to the attached drawings. As an example, a surrounding recognition support system 1 according to the present embodiment is applied to a vehicle C.

[Overall Structure]

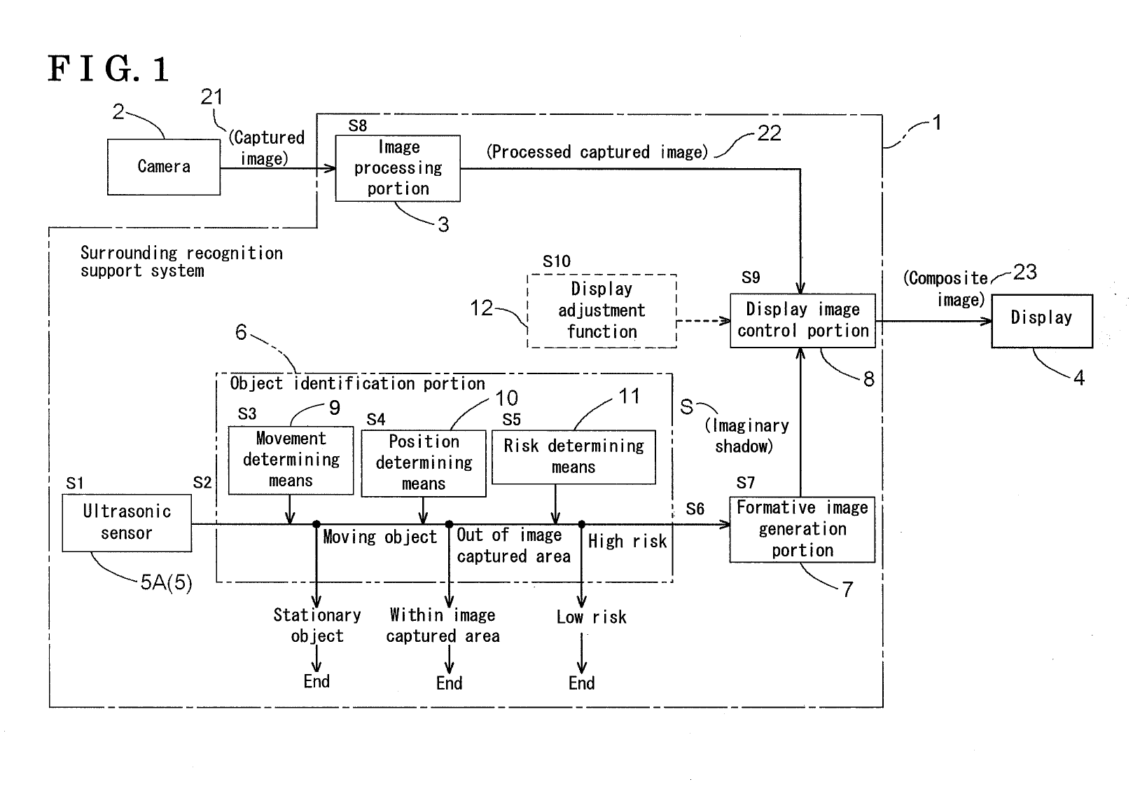

As illustrated in FIG. 1, the surrounding recognition support system 1 includes an image processing portion 3, ultrasonic sensors 5A each serving as an object position detecting means 5, an object identification portion 6, a formative image generation portion 7, and a display image control portion 8.

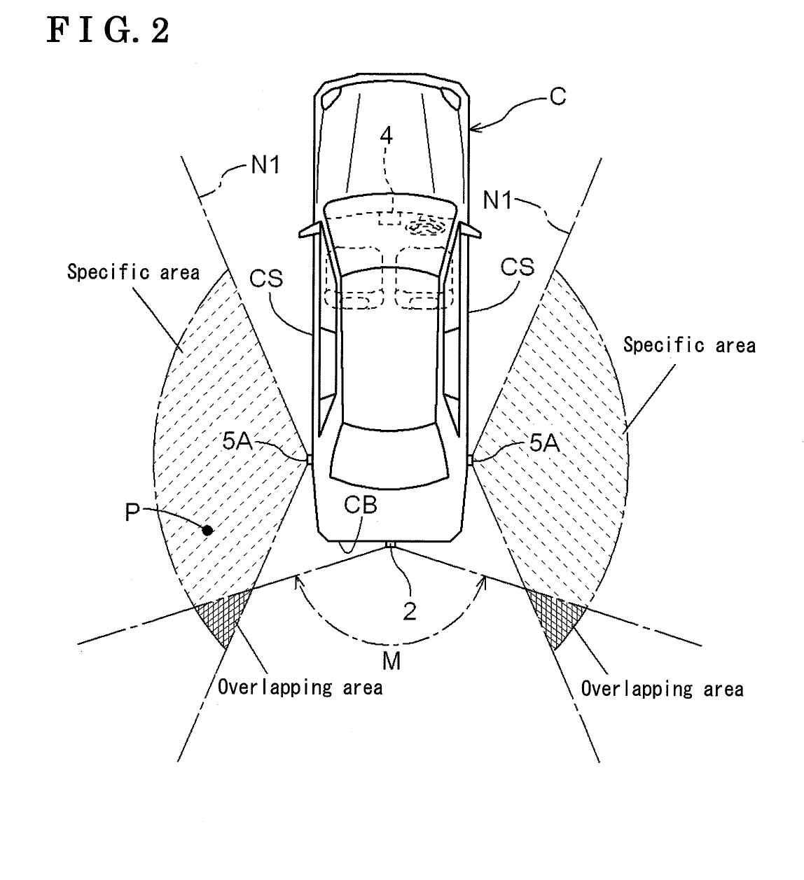

As illustrated in FIG. 2, a camera 2 serving as an image capturing device is provided at a vehicle rear surface CB for capturing an image of a rear of the vehicle C. In this case, the camera 2 is a so-called wide-angle rear view camera. An image captured area M of the camera 2 is specified so that an image of a minimum area necessary for a backward driving of the vehicle C can be captured. The image of the minimum area appears on a display screen 4 (hereinafter referred to as a display 4) serving as a display device mounted at a vehicle interior. When driving the vehicle backward for parking, for example, a driver confirms, by looking at the display 4, whether an obstacle or the like is present in the rear of the vehicle C. For the image displayed on the display 4, a direction from bottom to top in the display 4 corresponds to a direction of the vehicle C to be driven backward. In addition, a right side in the display 4 corresponds to a left side of the vehicle C while a left side in the display 4 corresponds to a right side of the vehicle C.

[Image Processing Portion]

The image processing portion 3 receives a captured image 21 by the camera 2 and processes the received image to look natural, not to be distorted, to the human eyes. The image processing is a known technology and thus details thereof such as a calculation operation will be omitted.

[Object Position Detecting Means]

As illustrated in FIG. 2, the ultrasonic sensor 5A serving as the object position detecting means 5 is provided at each vehicle side surface CS for the purpose of detecting a position of an object P that is present within an area from a side to a rear of the vehicle C. Each of the ultrasonic sensors 5A detects relative positions of the object P to the ultrasonic sensor 5A in time series.

A method for detecting an object by each of the ultrasonic sensors 5A will be briefly explained below. An ultrasonic wave transmitted by the ultrasonic sensor 5A hits the object P to thereby generate a reflected wave as a reflection of the ultrasonic wave, which is received back by the ultrasonic sensor 5A. The ultrasonic sensor 5A calculates a time interval between sending the ultrasonic wave and receiving the reflection to detect a relative position of the object P using a triangulation method, and the like. The ultrasonic sensor 5A has a known structure and thus details such as a calculation operation will be omitted.

A detection area N1 is specified to include an area from a side to a rear of the vehicle C. In particular, the detection area N1 desirably includes an area that tends to be a blind spot for the driver. In a case where an angle of the detection area N1 is equal to or smaller than 120 degrees, even the ultrasonic sensor 5A of lower power may be applicable. Further, in a case where the angle of the detection area N1 is equal to or smaller than 90 degrees, the detection ability is further enhanced even by the ultrasonic sensor 5A of lower power. According to the present embodiment, the angle of the detection area N1 is specified to be approximately 120 degrees.

According to the present embodiment, in order to securely detect the object P around a border of the image captured area M, the detection area N1 and the image captured area M are partially overlapped with each other to produce an overlapping area.

[Object Identification Portion]

The object identification portion 6 receives a detection result from each of the ultrasonic sensors 5A and identifies information of the object P present within the detection area N1. A specific area that should be specifically monitored or observed is defined beforehand within the detection area N1. The object identification portion 6 only identifies information of the object P that is present in the specific area. The specific area is determined on the basis of a distance to the object P from the vehicle C, an angle of the detection area N1, and the like. The specific area, however, may not be defined.

A relative movement and a relative speed of the object P to the vehicle C are calculated on the basis of data of relative positions of the object P in time series and data of movements of the vehicle C over the ground in time series. Then, it is determined whether the object P is a moving object or a stationary object. This determination serves as a movement determining means 9. When it is determined that the object P is determined to be the moving object, a process leading to a formative image generation is continued. When it is determined that the object P is determined to be the stationary object, the process is terminated. The object identification portion 6 includes the movement determining means 9 or the movement determining means 9 may be provided separately.

According to the aforementioned structure, the presence of the object P is visually alerted to the driver only in a case where the object P is the moving object that has a high possibility to collide with the vehicle C.

The object identification portion 6 performs a calculation operation based on position information of the object P that has been identified, and data related to the image captured area M specified beforehand from a specification and an installation state of the camera 2, such as a view angle, an installation position, and a direction of installation. Then, the object identification portion 6 determines whether the object P is present within the image captured area M or out of the image captured area M. This determination serves as a position determining means 10. When it is determined that the object P is present within the image captured area M, the process leading to the formative image generation is continued. When it is determined that the object P is present out of the image captured area M, the process is terminated. The object identification portion 6 includes the position determining means 10 or the position determining means 10 may be provided separately.

According to the aforementioned structure, even when the detection area N1 and the image captured area M are partially overlapped with each other by the use of the ultrasonic sensor 5A having the wide detection area N1, it can be determined whether the object P is present within the image captured area M or is present out of the image captured area M. Thus, a large selection of the object position detecting means 5 is available. Position and direction of an installation of the object position detecting means 5 are also flexibly specified to some extent to thereby reduce a restriction depending on vehicle types.

The object identification portion 6 determines a possibility of collision such as whether the object P is approaching the vehicle C. This determination serves as a risk determining means 11. In determining the possibility of collision, conditions serving as criteria for the possibility of collision such as a position of the object P relative to the vehicle C, an approaching direction and a speed of the object P, and the like are specified beforehand. When it is determined that a collision may occur, the process leading to the formative image generation is continued. When it is determined that a collision may not occur, the process is terminated. The object identification portion 6 includes the risk determining means 11 or the risk determining means 11 may be provided separately.

In addition, a degree of risk of a collision may be graded.

[Formative Image Generation Portion]

The formative image generation portion 7 generates an imaginary shadow S serving as a formative image based on position information of the object P identified by the object identification portion 6 when the object identification portion 6 determines the possibility of collision.

Because a shadow such as the imaginary shadow S can directly suggest a presence of an object, the imaginary shadow S effectively draws attention of the driver to the object P and strongly encourages the driver to look at surroundings of the vehicle C.

The imaginary shadow S is not necessarily approximated to an actual shadow of the object P in length, shape, direction, and the like. The present embodiment aims to alert the driver, who is focusing on the display 4, a presence of an object in a range from the side to the rear of the vehicle C that cannot be checked or confirmed through the display 4, and to encourage the driver to pay attention to an outside of the vehicle C. As long as the driver recognizes the presence of the object by looking at the imaginary shadow S and visually observes a direction where the object is present, the purpose of the present embodiment is adequately achieved. According to the same reason, in a case where multiple objects are detected, only one imaginary shadow S may be produced.

It is sufficient that at least the driver looks at the imaginary shadow S and finds out a direction where the object P is present. Thus, a position of the object P displayed on the display 4 should be determined on the basis of a position of the object P identified by the object identification portion 6. That is, the formative image generation portion 7 generates the imaginary shadow S at a lower left portion on the display 4 when the ultrasonic sensor 5A provided at the right side of the vehicle C detects the object P. On the other hand, the formative image generation portion 7 generates the imaginary shadow S at a lower right portion on the display 4 when the ultrasonic sensor 5A provided at the left side of the vehicle C detects the object P.

According to the aforementioned structure, the driver recognizes an approximate position of the object P and accurately visually observes a direction where the object P is present.

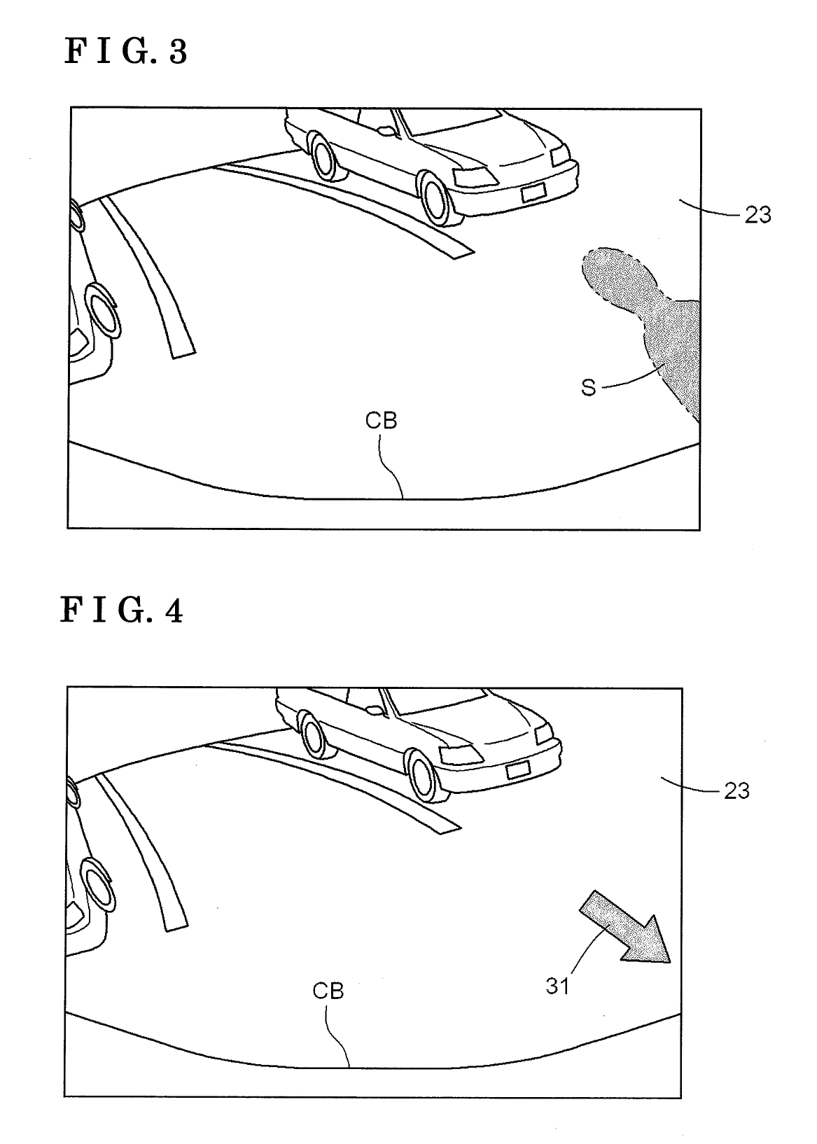

In addition, as illustrated in FIG. 3, the imaginary shadow S formed into a human shape may effectively draw attention of the driver. The imaginary shadow S is constant in direction, length, shape, and the like, and is displayed at a specific position on the display 4. In this case, however, it is acceptable to detect a position of the sun or a light source, a shape of the object P in three dimensions for calculation of an actual shadow of the object P so as to display the imaginary shadow S corresponding to the actual shadow on the display 4.

The formative image is not limited to the imaginary shadow S and may be other forms or shapes as long as they suggest the driver the presence of the object P within the specific area out of the image captured area M. For example, as shown in FIG. 4, an arrow 31 indicating a direction where the object P is present may be used as the formative image.

In a case where the degree of risk is graded by the risk determining means 11, an intensity, a size, and the like of the shadow may be varied to generate the imaginary shadow S depending on the degree of risk. In this case, the driver is alerted, depending on a situation, thereby achieving the further advanced surrounding recognition support system 1.

[Display Image Control Portion]

The display image control portion 8 performs an image compositing process on the imaginary shadow S and a captured image on which the image processing has been performed by the image processing portion 3, i.e., a processed captured image 22. A resulting composite image 23 by the display image control portion 8 is output to the display 4. In a case where the imaginary shadow S is not produced, the processed captured image 22 is directly output to the display 4.

The display image control portion 8 includes a display adjustment function 12 for enhancing brightness of surroundings of the imaginary shadow S. Thus, the imaginary shadow S is emphasized to thereby cause the driver to easily recognize the imaginary shadow S.

The display adjustment function 12 may include not only adjustment of brightness but also adjustment of luminance, color saturation, and the like. In such case, when the imaginary shadow S is shaded depending on the degree of risk, the driver securely recognizes the imaginary shadow S.

[Process Flow of Surrounding Recognition Support System]

A process flow of the surrounding recognition support system 1 will be explained with reference to FIG. 1. Steps in the process flow performed by the surrounding recognition support system are indicated by S1, S2, and the like, in FIG. 1. When a backward operation of the vehicle C for parking, and the like is started, the camera 2 starts capturing an image of a rear of the vehicle C while at the same time each of the ultrasonic sensors 5A starts detection.

The image processing portion 3 receives the captured image 21 by the camera 2 and performs the image processing on the captured image 21 that has been received (S8). The captured image after the image processing, i.e., the processed captured image 22, is output to the display image control portion 8.

In a case where the object P is present within the detection area N1 of the ultrasonic sensor 5A, the ultrasonic sensor 5A detects a position of the object P (S1). The object identification portion 6 then receives the detection result of the ultrasonic sensor 5A and identifies position information of the object P present only within the specific area (S2).

The object identification portion 6 calculates a movement and a speed of the object P relative to the vehicle C based on data of relative positions of the object P and data of movements of the vehicle C over the ground. As a result, the movement determining means 9 determines whether the object P is a moving object or a stationary object (S3). When it is determined that the object P is the moving object, the process leading to the formative image generation is continued. When it is determined that the object P is the stationary object, the process is terminated.

Next, the position determining means 10 determines whether the object P that is determined to be the moving object is present within the image captured area M or out of the image captured area M (S4). When it is determined that the object P is present out of the image captured area M, the process leading to the imaginary shadow generation is continued. When it is determined that the object P is present within the image captured area M, the process is terminated.

The risk determining means 11 determines the possibility of collision of the object P present out of the image captured area M with the vehicle C (S5). When the high possibility of collision is determined, the process leading to the imaginary shadow generation is continued. When the low possibility of collision is determined, the process is terminated. Information of the object P on which the high possibility of collision is determined by the risk determining means 11 is output to the formative image generation portion 7 (S6).

When receiving information of the object P, the formative image generation portion 7 generates the imaginary shadow S displayed at the lower left portion or lower right portion on the display 4 based on the position information of the object P (S7). As described above, only one imaginary shadow S is produced even when the single ultrasonic sensor 5A detects the multiple objects P. In a case where one of the ultrasonic sensors 5A detects the object(s) P while the other one of the ultrasonic sensors 5A detects the other object(s) P, the respective imaginary shadows S are produced and displayed at the lower left portion and the lower right portion on the display 4. Data of the imaginary shadow S produced by the formative image generation portion 7 is output to the display image control portion 8.

The display image control portion 8 receives data of the imaginary shadow S and the processed captured image 22 for conducting an image compositing process thereon (S9). In addition, the display adjustment function 12 enhances the brightness of the surroundings of the imaginary shadow S (S10). The composite image 23 resulting from the image compositing process is output to the display 4. The process leading to the formative image generation is completed through S3, S4, and S5 and, when the imaginary shadow S is not produced, the processed captured image 22 is directly output to the display 4.

In a case where a parking assist apparatus for assisting a driving operation is mounted to the vehicle C, a camera, an image processing portion, and a display provided at the parking assist apparatus are usable as the camera 2, the image process portion 3, and the display 4 for the image captured area M. In addition, a sensor for the parking assist apparatus may be used as the object position detecting means 5. Further, a sensor used for detecting an obstacle that possibly makes contact with a door such as a backdoor of a hatchback while the door is opening or closing may be used as the object position detecting means 5. In such cases, the existing apparatus is usable, which leads to the surrounding recognition support system at low cost.

The aforementioned embodiment is not limited to the captured image of a rear of a vehicle by the rearview camera and may be applicable to the captured image of a side of the vehicle by a side camera.

### Second Embodiment

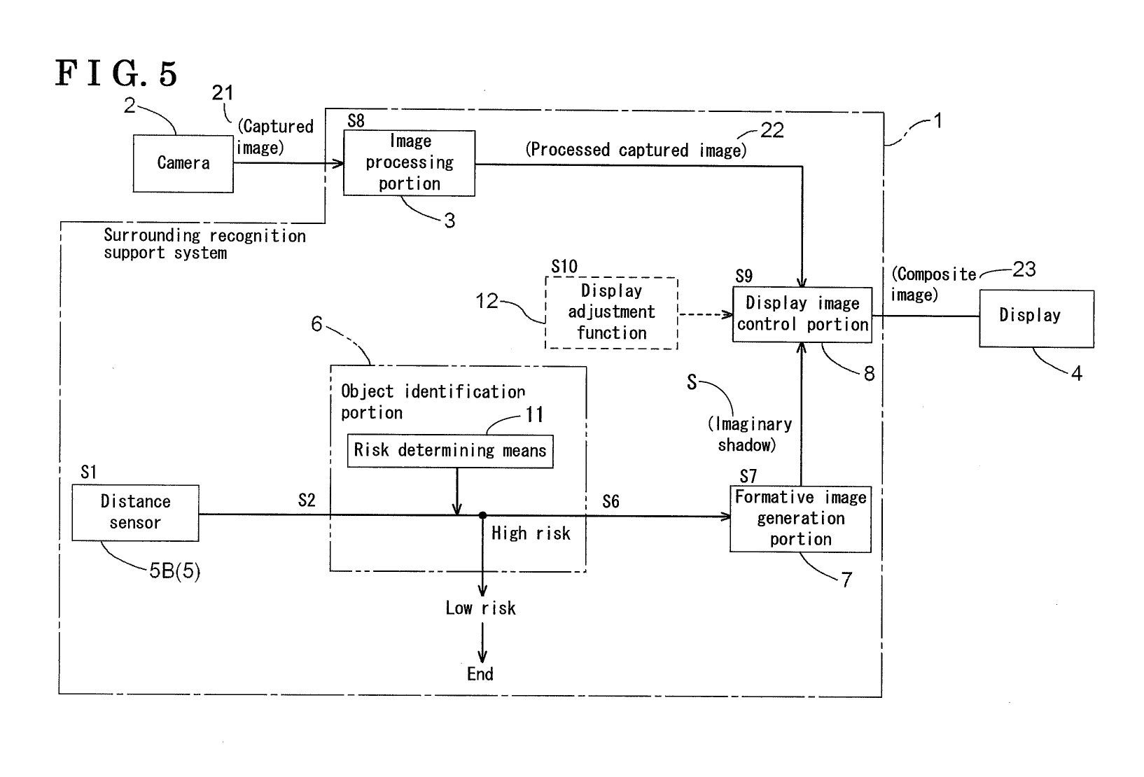

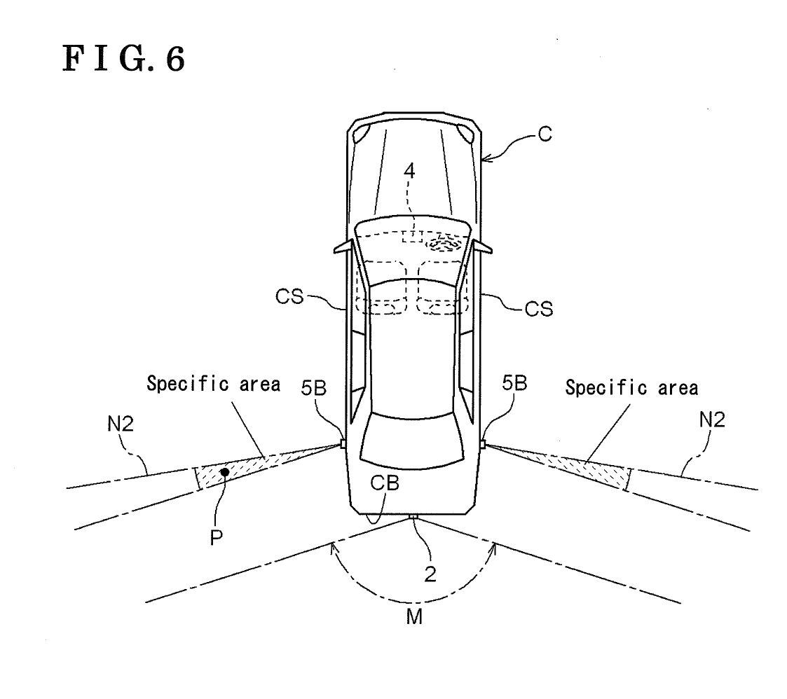

A second embodiment in which sonar-type distance sensors 5B having directionality are used as the object position detecting means 5 will be explained with reference to FIGS. 5 and 6. In FIG. 5, a point sensor is used as each of the distance sensors 5B, for example. The distance sensor 5B measures a distance therefrom to the object P along with the movement of the vehicle C. Structures of the second embodiment same as those of the aforementioned first embodiment bear the same reference numerals and explanations thereof will be omitted.

As illustrated in FIG. 6, the distance sensors 5B are provided at both vehicle side surfaces CS of the vehicle C so as to face slightly rearward of the vehicle C. More specifically, each of the distance sensors 5B is arranged in such a manner that the image captured area M of the camera 2 is prevented from overlapping with a detection area N2 of the distance sensor 5B. Thus, in a case where the object P is detected by the distance sensor 5B, it is determined that the object P is present out of the image captured area M. Thus, the position determining means 10 is not provided according to the second embodiment.

In addition, because the vehicle C is moving and the angle of the detection area N2 is narrow as illustrated in FIG. 6, a time period for detecting the object P tends to be short. Thus, according to the second embodiment, the movement determining means 9 is not provided.

Further, the angle of the detection area N2 of the distance sensor 5B such as the point sensor is small and therefore a detectable distance is limited. As a result, the detection area itself is equal to the specific area.

The object identification portion 6 identifies a position of the object P relative to the vehicle C based on a distance between the vehicle C and the object P detected, and a direction where the distance sensor 5B is installed.

The degree of risk of a collision may be graded by the risk determining means 11 according to the second embodiment.

In a case where the multiple distance sensors 5B are provided, relative movements and speeds of the object P to the vehicle C are calculated in time series in the same way as the first embodiment.

A laser radar used for driving assistance, for example, may be used as the distance sensor 5B.

In addition, not only the point sensor having directionality but also a scan-type point sensor may be used as the distance sensor 5B. In this case, the detection area N2 is specified to be large, however, conditions such as a relative speed between the vehicle C and the object P that may possibly collide with the vehicle C, the angle range to be scanned, and the detection distance should be precisely specified.

According to the aforementioned embodiments, the formative image that suggests the presence of the object P within the specific area and out of the image captured area M of the camera 2 is displayed on the display 4 that displays the captured image. Thus, the driver turns his/her eyes from the display 4 to the object P around the vehicle C so as to confirm the presence of the object P suggested by the formative image. As a result, the driver can safely drive and park the vehicle C without missing the object P around the vehicle by excessively focusing on the display 4.

According to the aforementioned embodiments, a position of the formative image displayed on the display 4 is determined on the basis of a position of the object P identified by the detection result of the object position detecting means 5.

The formative image is displayed on the display 4 based on an actual position of the object P. Thus, the driver recognizes an approximate position of the object P and accurately visually observes a direction where the object P is present.

The surrounding recognition support system 1 further includes the movement determining means 9 determining whether the object P is a moving object or a stationary object, and generates the formative image when it is determined that the object is the moving object.

The formative image is displayed on the display 4 only when the object P present out of the image captured area M is the moving object. Of course, the vehicle C has a high possibility to collide with the moving object as compared to the stationary object. That is, only in a case of high possibility of collision, the driver is alerted to visually check the surroundings of the vehicle C.

The surrounding recognition support system 1 further includes the position determining means 10 determining whether the object P detected by the object position detecting means 5 is positioned within the image captured area of the camera 2 or is positioned out of the image captured area, the image captured area of the camera 2 and a detection area of the object position detecting means 5 being overlapped with each other to produce an overlapping area.

Even when the object position detecting means 5 (ultrasonic sensor 5A) having the large detection area N1 is used to thereby generate the overlapping area between the detection area N1 and the image captured area M, it can be accurately detected whether the object P is within the image captured area M or out of the image captured area M. In this case, whether the object P is within the image captured area M or out of the image captured area M is determined because an installation position, direction, and a view angle of the camera 2 are known in design. Thus, a large selection of the object position detecting means 5 is available. Position and direction of an installation of the object position detecting means 5 are also flexibly specified to some extent to thereby reduce a restriction depending on vehicle types.

The surrounding recognition support system 1 further includes the risk determining means 11 determining a possibility of a collision of the vehicle C with the object P.

According to the aforementioned embodiments, the possibility of collision of the vehicle C with the object P is determined. Thus, existence or nonexistence of the formative image on the display 4, color, brightness, and the like of the formative image are freely selectable depending on the degree of risk of collision. As a result, the driver is accurately alerted depending on a circumstance to thereby provide a further advanced surrounding recognition support system.

According to the aforementioned embodiments, the formative image is equal to the imaginary shadow S that suggests a presence of the object.

According to the aforementioned embodiments, the imaginary shadow S is displayed on the display 4 to thereby alert the driver to the object P. The shadow is related to any objects and directly suggests the presence of the object. Thus, the imaginary shadow S effectively draws attention of the driver to the object P and strongly encourages the driver to look at surroundings of the vehicle C.

According to the aforementioned embodiments, the display image control portion 8 includes the display adjustment function 12 for enhancing a brightness around the imaginary shadow S when the imaginary shadow S is displayed on the display 4.

Because brightness around the imaginary shadow S on the display 4 is enhanced, the imaginary shadow S is easily viewable.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A surrounding recognition support system, comprising:
an image processing portion receiving a captured image of a surrounding of a vehicle from an image capturing device and performing an image processing on the captured image received;
an object position detecting means detecting a position of an object present in a vicinity of the vehicle;
an object identification portion identifying information related to the object based on a detection result of the object position detecting means;
a formative image generation portion generating a formative image that suggests a presence of the object existing within a specific area and existing out of an image captured area of the image capturing device, the object being identified by the object identification portion; and
a display image control portion performing an image compositing process on the formative image and the captured image on which the image processing has been performed, and outputting a composite image obtained resulting from the image compositing process to a display device installed within the vehicle.

2. The surrounding recognition support system according to claim 1, wherein a position of the formative image displayed on the display device is determined on the basis of a position of the object identified by the detection result of the object position detecting means.

3. The surrounding recognition support system according to claim 1, further comprising a movement determining means determining whether the object is a moving object or a stationary object, and generates the formative image when it is determined that the object is the moving object.

4. The surrounding recognition support system according to claim 1, further comprising a position determining means determining whether the object detected by the object position detecting means is positioned within the image captured area of the image capturing device or is positioned out of the image captured area, the image captured area of the image capturing device and a detection area of the object position detecting means being overlapped with each other to produce an overlapping area.

5. The surrounding recognition support system according to claim 1, further comprising a risk determining means determining a possibility of a collision of the vehicle with the object.

6. The surrounding recognition support system according to claim 1, wherein the formative image is equal to an imaginary shadow that suggests a presence of the object.

7. The surrounding recognition support system according to claim 6, wherein the display image control portion includes a display adjustment function for enhancing a brightness around the imaginary shadow when the imaginary shadow is displayed on the display device.
